(19) United States
(12) Patent Application Publication
(10) Pub. No.: US 2013/0226415 A1
(43) Pub. Date: Aug. 29, 2013

(54) Continuously Productive Machine During Hydraulic System Overheat Condition

(71) Applicants: Sage Frederick Smith, Apex, NC (US); Brian Franklin Taggart, Angier, NC (US); Clayton Lucas Padgett, Raleigh, NC (US); John Sale Bibb, III, Apex, NC (US); Michael Charles Rossi, Cary, NC (US); Kimberly Melissa Stanek, Dunlap, IL (US)

(72) Inventors: Sage Frederick Smith, Apex, NC (US); Brian Franklin Taggart, Angier, NC (US); Clayton Lucas Padgett, Raleigh, NC (US); John Sale Bibb, III, Apex, NC (US); Michael Charles Rossi, Cary, NC (US); Kimberly Melissa Stanek, Dunlap, IL (US)

(73) Assignee: CATERPILLAR INC., Peoria, IL (US)

(21) Appl. No.: 13/406,983

(22) Filed: Feb. 28, 2012

(51) Int. Cl. F15B 13/00

(52) U.S. Cl. 701/50

(57) ABSTRACT

A skid steer type machine is equipped with an overheat protection algorithm that keeps the machine productive even when the hydraulic system is in an overheated condition. When an elevated hydraulic fluid temperature is detected, an electronic controller derates a pump of the hydraulic system to limit pump output to a reduced flow rate down from a rated flow rate. The hydraulic fluid tends to cool down when the pump is derated, but the machine remains productive while the hydraulic system is cooling down.

### TECHNICAL FIELD

The present disclosure relates generally to machines that utilize hydraulically powered implements, and more particularly to a skid steer type machine with a strategy to maintain productivity during hydraulic system overheat conditions.

### BACKGROUND

Today's skid steer type machines can accommodate a wide array of implements to perform virtually any conceivable task. At one end of the spectrum, the skid steer type machine can be equipped with a loader bucket that can be lifted and tilted to perform a wide variety of earth moving operations. At the opposite end of the spectrum might be implements such as cold planars that require relatively large hydraulic fluid flow rates to perform the energy intensive work of removing pavement. Between these two extremes are numerous implements that require lower flow rates to perform work. Among these are brooms, post hole diggers, hydraulic hammers, mulchers and many, many others.

Depending upon the machine, the hydraulic system can potentially overheat, especially when utilizing an energy intensive implement during high temperature ambient conditions. Because an expensive catastrophic failure is a real possibility during severe and prolonged hydraulic overheat conditions, some modern machines are equipped with overheat protection algorithms that shut down the machine until hydraulic fluid temperatures return to normal operating temperatures. In another example taught in Japanese patent JP2005290890, a proactive strategy limits pump output to prevent the hydraulic system from being put into an overheated state when operating an energy intensive implement in a hot environment. In the former case, productivity losses can be substantial during intervals in which the machine is shut down and performing no work. In the latter case, productivity losses inherently result when the machine pump output is limited without an overheat condition ever occurring.

The present disclosure is directed toward one or more of the problems set forth above.

### SUMMARY

In one aspect, a skid steer type machine includes a machine body supported by a left side propulsion drive and a right side propulsion drive that are independently operable. An operator control station is attached to the machine body between the left and right propulsion drives. An engine is positioned rearward of the operator control station on the machine body. A hydraulic system includes a pump driven by the engine. A temperature sensor is operably positioned to sense a hydraulic fluid temperature. An electronic controller is in communication with the hydraulic system and the temperature sensor, and programmed to execute an overheat protection algorithm configured to de-rate the pump responsive to an elevated hydraulic fluid temperature. The hydraulic system is operable up to a rated flow rate when the hydraulic fluid temperature is below an elevated temperature threshold, but operable up to a reduced flow rate, which is greater than half the rated flow rate, when derated.

In another aspect, a method of operating a machine includes communicating propulsion control signals and implement control signals from an operator control station to an electronic controller. The machine is maneuvered with power provided by an engine responsive to the propulsion control signals. A pump of a hydraulic system is driven by the engine, and hydraulic fluid is circulated to an implement of the hydraulic system responsive to the implement control signal. The implement performs work while a hydraulic fluid temperature is determined. When the hydraulic fluid temperature is detected as indicating an elevated hydraulic fluid temperature, the pump is derated from a rated flow rate to a reduced flow rate responsive to the elevated hydraulic fluid temperature. The implement continues to perform work at the reduced flow rate after derating the pump.

In still another aspect, a machine includes a machine body supported by a propulsion system. An operator control station and an engine are attached to the machine body. A hydraulic system includes a pump driven by the engine. A temperature sensor is operably positioned to sense a hydraulic fluid temperature. An electronic controller is in communication with the hydraulic system and the temperature sensor, and programmed to execute an overheat protection algorithm configured to derate the pump responsive to an elevated hydraulic fluid temperature. The pump is operable up to a rated flow rate when the hydraulic fluid temperature is below an elevated temperature threshold, but operable up to a reduced flow rate when derated. The reduced flow rate corresponds to a hydraulic system cool down flow rate while maintaining the engine operating up to an engine rated condition to maintain a machine productivity when the pump is derated.

### BRIEF DESCRIPTION OF THE DRAWINGS

FIG. 1 is a side view of a machine according to the present disclosure;

FIG. 2 is a schematic view of a hydraulic system for the machine of FIG. 1; and

FIG. 3 is a logic flow diagram for operating the machine of FIG. 1.

### DETAILED DESCRIPTION

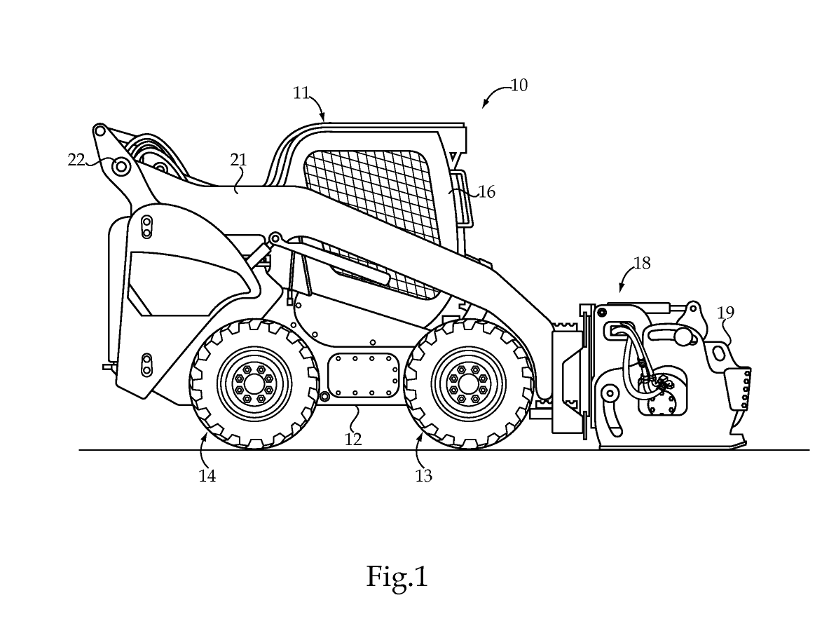

Referring to FIG. 1, a machine 10 according to the present disclosure includes a propulsion system 13. Although the present disclosure shows a wheeled propulsion system, other propulsion systems including but not limited to tracks or maybe even marine propellers would fall within the scope of the present disclosure. Although machine 10 is illustrated as a skid steer type machine 11, any machine that includes an engine 25 and a hydraulic system that operates an implement 18 could fall within the scope of the present disclosure. For instance, other machines might include a wheel loader with a work intensive implement attached in place of the bucket, or maybe an excavator with a work intensive hydraulic tool substituted in place of the excavator bucket.

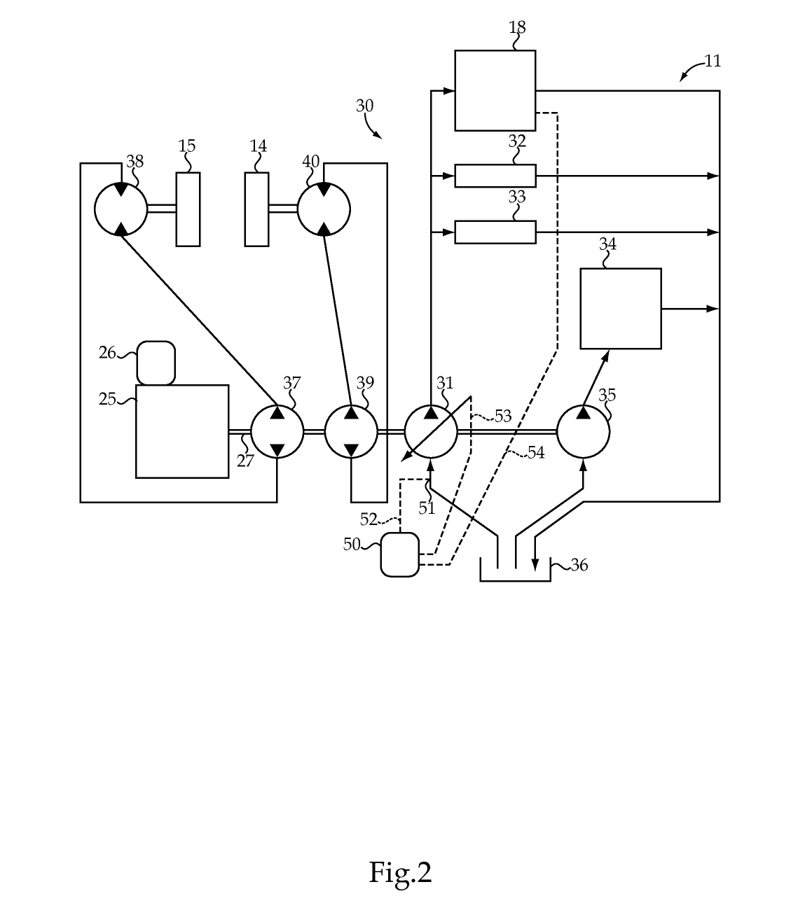

Skid steer type machines include skid steer loaders and compact track loaders, which are terms of art in the relevant industry. Skid steer type machines may be characterized by a right side propulsion drive 14 that is independently operable relative to a left side propulsion drive 15 (FIG. 2). Skid steer type machines are also characterized by the inclusion of a boom 21 that flanks both sides of an operator control station 16 at about operator shoulder level, and pivots about hinge point 22 located behind the operator when raising and lowering an implement 18 located in front of the operator. A skid steer type machine is also characterized by engine 25 being positioned immediately rearward of the operator control station 16 on a compact machine body 12. Skid steer type machine 11 is shown with an energy intensive implement 18 in the form of a cold planar 19 that may be among the most energy intensive implements for skid steer type machines generally known at the time of this disclosure. Nevertheless, the present disclosure contemplates any energy intensive implement currently known such as concrete cutters, tree mowers and other future implements of any type. Cold planar 19 may have a rated work tool flow rate of hydraulic fluid on the order of 150 lpm (liters per minute). This rated work tool flow rate might be considered a super high flow rate, whereas a standard implement, such as a broom, might have a standard rated work tool flow rate on the order of 80 lpm.

In one aspect of the present disclosure, the rated work tool flow rate of the energy intensive implement 18 has a super high flow rate capable of overheating a hydraulic system of machine 10 during sustained use in a hot ambient environment. Machine 10 may preferably be designed to operate standard flow rate implements in hot ambient environments without any significant risk of overheating the hydraulic system for implement 18.

Referring in addition to FIG. 2, a hydraulic system 30 schematic for skid steer type machine 11 according to one example embodiment is illustrated. In this specific example, engine 25, which is controlled by an electronic engine controller 26 directly drives an implement pump 31, an auxiliary pump 35, a left side propulsion pump 37 and a right side propulsion pump 39. The direct drive is schematically shown by a shaft symbol 27, meaning that each of the pumps 31, 35, 37 and 39 rotate at a fixed rate with respect to engine 25, such as via meshed gearing, chains, belts or shafts.

Much of what was shown in FIG. 2 is merely illustrates environmental features of skid steer type machine 11 for one example embodiment. For instance, left side propulsion pump 37 drives left side propulsion drive 15 via a left side motor 38, whereas right side propulsion pump 39 drives right side drive 14 via a right side motor 40. In addition, auxiliary pump 35, in the example embodiment, provides hydraulic fluid to auxiliary systems, such as a cooling fan and maybe subsystems associated with ride comfort control. Also in the case of skid steer type machine 11, implement pump 31, which may be a variable angle swash plate pump, provides hydraulic fluid to a lift cylinder 32, a tilt cylinder 33 and the implement 18, before returning the hydraulic fluid to tank 36 for recirculation anywhere in hydraulic system 30. The angle of the swash plate for pump 31, and hence the output from implement pump 31 may be controlled by signals generated by electronic controller 50 and communicated to pump 31 via communication line 53.

The communication and control between electronic controller 50 and pump 31 may actually appear on machine 11 as electronic controller adjusting electrical actuators associated with valves to supply hydraulic fluid to hydraulic actuators that vary the angle of the swash plate for pump 31. In order to monitor the hydraulic fluid temperature in hydraulic system 30, a temperature sensor 51 might be operably positioned to sense hydraulic fluid temperature entering the inlet of implement pump 31, and communicate that temperature to electronic controller 50 via communication line 52.

When an implement 18 is attached to skid steer type machine 11, the implement may communicate its rated work tool flow rate to electronic controller 50 via communication line 54. This information allows the electronic controller to configure control signals to pump 31 and configure controls in the operator control station 16 to limit flow rates to the implement 18 up to the rated work tool flow rate, which may be well below the capacity of pump 31. For instance, if implement 18 were a broom requiring a max flow rate corresponding to a standard flow rate of maybe 80 lmp, electronic controller 50 could be configured to control pump 31 to limit flow to implement 18 up to 80 lmp regardless of engine speed, and apparent control requests from the operator control station. On the other hand, if implement 18 is a work intensive tool, such as a cold planar 19, that has a rated work tool flow rate on the order of maybe 150 lpm, electronic controller 50 might be configured to allow pump 31 to provide a flow rate up to 150 lmp provided that other constraints, such as overheat protection, permit that super high flow rate.

In the illustrated embodiment, electronic controller 50 is separate from electronic engine controller 26. Those skilled in the art will appreciate that the functions of those two controllers could be merged into one controller or split out into more than two electronic controllers without departing from the scope of the present disclosure. Thus, “an electronic controller” may mean one, two or more separate tangible electronic controllers. Although not necessary, electronic engine controller 26 may be programmed to execute a conventional engine overheat algorithm that is configured to derate the engine responsive to an elevated engine temperature. Those skilled in the art will recognize that the features of such an algorithm are well known and will not be taught again here. Thus, one could expect electronic engine controller 26 to monitor engine temperature and derate the engine responsive to an engine temperature exceeding an engine overheat temperature threshold, but permit the engine to operate up to a rated power output when the engine temperature is below the engine overheat temperature threshold. Thus, machine 10 may be equipped with separate logic to allow the engine to protect itself from overheat conditions regardless of what is happening temperature wise, or otherwise in hydraulic system 30.

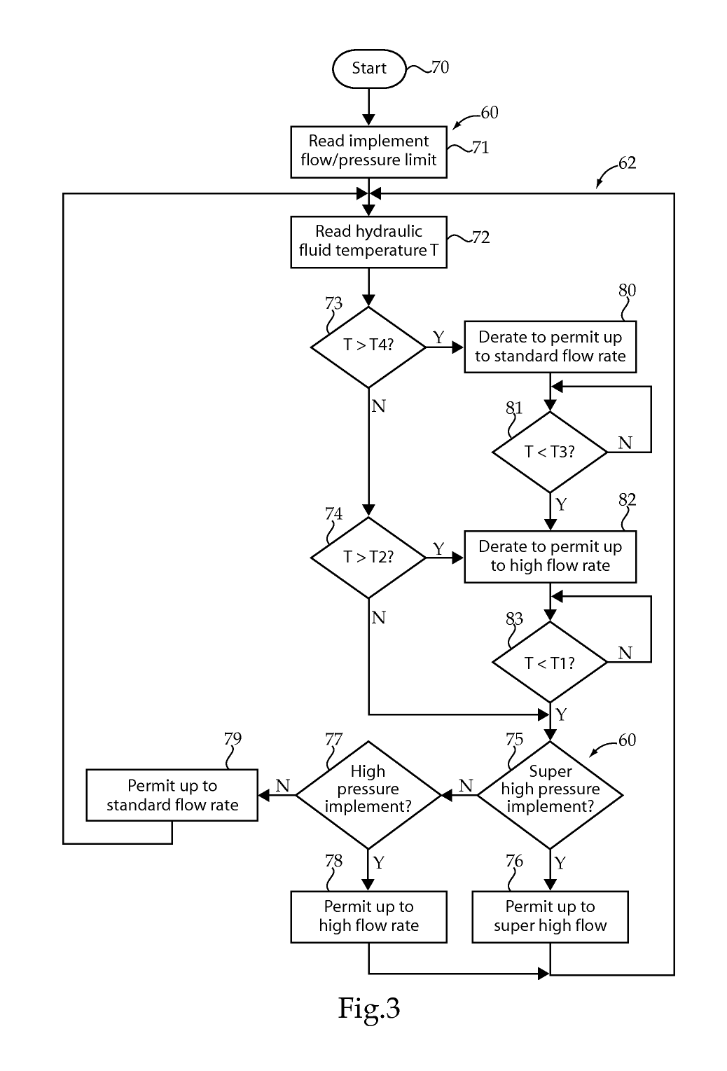

Referring now in addition to FIG. 3, a combined example work tool flow rate configuration algorithm 60 is illustrated with an example logic flow diagram for an overheat protection algorithm 62 that would both be programmed for execution in electronic controller 50. After start 70, electronic controller 50 reads the implement rated work tool flow rate at box 71 and this information is communicated to electronic controller 50 via communication line 54. Next, electronic controller 50 reads the hydraulic fluid temperature at box 72. At query 73, electronic controller determines whether the hydraulic fluid temperature is greater than a fail safe temperature threshold T4. If not, the logic advances to query 74 where electronic controller 50 determines whether the hydraulic fluid temperature T is greater than a first hydraulic fluid temperature threshold T2 indicative of a need to cool down the hydraulic system. If the query 74 returns a negative, the logic then proceeds back to a work tool flow rate configuration algorithm logic where the electronic controller 50 queries whether the implement 18 is a super high pressure implement at query 75. If so, electronic controller 50 permits the hydraulic flow rate up to the super high flow rate responsive to control signals from the operator control station 16. If the implement 18 is not a super high pressure implement, the logic queries whether the implement 18 is a high pressure implement at query 77. This aspect of the logic may be optional, as it presupposes a class of implements that are rated to a work flow rate between that of a standard flow rate and a super high flow rate. Examples might include certain harvesters or mowers. If the query 77 returns an affirmative, the electronic controller will permit flow rates to implement 18 up to a predetermined high flow rate at box 78. If the electronic controller 50 determines that implement 18 is not a high pressure implement, the electronic controller 50 will permit flow rates from pump 31 up to a standard flow rate at box 79. In one specific example, a standard flow rate might be 80 lpm, a high flow rate might be 120 lpm, and a super high flow rate might correspond to 150 lpm. Nevertheless, those skilled in the art will recognize that these magnitudes are mere examples and are not intended to limit the scope of the present disclosure. After setting flow rates permitted by pump 31 to the implement 18, the logic returns back to again read the hydraulic fluid temperature T at box 72.

Machine 10 and specifically skid steer type machine 11 may be engineered so that overheat queries 73 and 74 rarely, if ever return an affirmative response. For instance, machine 10 may be engineered such that the cooling capacity of the hydraulic system 30 is such that the hydraulic fluid temperature ever exceeding a fail safe temperature threshold T4 is only realistically possible when the machine is properly maintained and operating in an extremely hot ambient temperature environment utilizing a work intensive tool such as a cold planar 19 as illustrated in FIG. 1. However, if the hydraulic fluid temperature ever exceeds a fail safe temperature T4, which may be on the order of 93° C. in one specific example, the overheat protection algorithm 62 is configured to derate pump 31 up to the standard flow rate. In the specific example, pump 31 would be derated to limit flow rates that may have been as high as 150 lpm but only permit a flow rate up to 80 lpm if the hydraulic fluid temperature exceeds a fail safe temperature T4. Machine 10 may then be configured to allow the hydraulic fluid temperature to cool down while still permitting the machine to be productive while maintaining the engine operating up to an engine rated condition because the engine may be unaffected by an elevated temperature in hydraulic system 30.

The derated flow rate for pump 31 may be chosen by carefully understanding how machine 10 behaves. In otherwords, the derated flow rate should be a flow rate that inherently causes the hydraulic fluid temperature T to cool down at the reduced flow rate, which may be greater than half of the rated work tool flow rate for the implement 18. Although not illustrated, the derating of pump 31 at box 80 might be communicated to the operator in operator control station 16 audibly and/or visibly, such as using a buzzer and/or lighted blinking warnings. As machine 10 continues to work with the reduced flow rate, the logic next determines whether the hydraulic fluid temperature has dropped below a temperature T3, which ought to be substantially lower than temperature T4 so that a partial re-rating of the pump up to a high flow rate at box 82 can be accomplished without hysteresis. Thus, if fail safe temperature T4 was 93° C., partial re-rate temperature T3 might be on the order of 91° C. to avoid hysteresis in the logic hunting between different flow rates when the hydraulic fluid temperature is in the vicinity of the temperature T4. If the query 81 returns a negative response, the electronic controller 50 continues the pump 31 at a derated condition allowing the machine 10 to continue to work, but at a reduced output until query 81 returns an affirmative response. At box 82 the electronic controller limits the output of pump 31 up to a high flow rate, which may correspond to a cool down derate in which one could expect hydraulic temperature to cool during continued operation in even hot ambient environments. As the cool down continues, the logic queries whether the hydraulic fluid temperature T has dropped bellow a re-rate temperature T1 at query 83. If not, the electronic controller continues to limit pump output up to the high flow rate. T1 might be set at a temperature substantially lower than temperature T2 to avoid hysteresis. For instance, temperature T2 might be on the order of 90° C. and T1 might be on the order of 88° C. so that the logic waits until the hydraulic fluid T is substantially below the first elevated temperature of T2 before re-rating pump 31.

Those skilled in the art will appreciate that the logic flow illustrated in FIG. 3 could be illustrated and programmed in many different ways with or without the step wise logic without departing from the present disclosure. For instance, a simpler logic that derates the pump 31 above an elevated temperature but re-rates below that elevated temperature would still fall within the scope of the present disclosure. However, FIG. 3 illustrates a step wise partial derate and full derate of pump 31 responsive to hydraulic fluid temperature being in a normal range (below 90° C.) in a cool down range between (90° C. and 93° C.), and a fail safe range above (93° C.). Those skilled in the art will appreciate that in some pumps, such as swash plate pumps, the hydraulic fluid itself provides some lubrication for proper functioning of the pump and that hydraulic fluid lubricity decreases at elevated temperatures. Thus, the logic according to the present disclosure can prevent potential catastrophic failure due to pump 31 losing proper lubricity due to an elevated hydraulic fluid temperature. If machine 10 is well designed and properly maintained, the overheat protection algorithm 62 may never have to take action to derate pump 31. In otherwords, the protection provided by overheat protection algorithm 62 may only occur in those rare cases when implement 18 is a energy intensive work tool being utilized with sustained operation in a high temperature ambient environment.

Those skilled in the art will recognize that there is more than one way to derate the pump 31 in case of an overheat condition. The previous example suggests that one way to derate the pump is to change the displacement of pump 31. An equivalent way could be to leave the pump displacement for pump 31 unchanged, but change the displacement of the motor of the implement 18 being powered by the pump 31. For instance, instead of reducing the displacement of pump 31 responsive to an overheat condition, the electronic controller 50 might increase the displacement of the motor for implement 18 to produce the same net result, in that the hydraulic circuit is performing less work and is thus able to cool. In the context of the present disclosure, derating the pump means changing the displacement of pump 31, changing the displacement of a motor for the implement 18, or both in a manner that causes the hydraulic circuit to do less work so that the hydraulic fluid can cool.

### INDUSTRIAL APPLICABILITY

The present disclosure finds potential application in any machine that includes an engine that powers a pump of a hydraulic system that performs work using an implement. The present disclosure finds specific application in skid steer type machines 11 with the capability of utilizing a wide variety of different implements with different flow rate requirements. For instance, at one end of the spectrum might be a bucket implement with zero hydraulic fluid flow, and at the other end of the spectrum might be a cold planar that can operate with a rated work tool flow rate up to 150 lpm, and many, many other implements in between these two extremes. The present disclosure is also specifically applicable to machines with a need to remain productive even when operating in high temperature ambient environments using work intensive implements. Finally, the present disclosure is generally applicable to machines where there is a desire to protect the hydraulic system from damage due to an elevated fluid temperature automatically without operator intervention, while permitting the machine to remain productive and without undermining machine mobility by continuing to allow the engine to operate up to a full rated power output when the hydraulic system overheats.

In one specific example as to how the present disclosure could reveal itself in a real world application, an operator might attach a work intensive tool, such as a cold planar 19 to a skid steer type machine 11 as shown in FIG. 1. When this is done, electronic controller 50 will read the rated work tool flow rate for cold planar 19 and permit pump 31 to provide that flow rate as long as the hydraulic fluid temperature T remains in a normal operating range, such as below 90° C. If the operator happens to be performing that work in a hot ambient environment, or if the machine is not properly maintained such as by debris being caught in a hydraulic fluid cooler, the overheat protection algorithm 62 will automatically derate pump 31 to protect the machine 10 from potential damage that could be caused by an elevated hydraulic fluid temperature. However, the same logic will allow the pump to be re-rated as the hydraulic fluid temperature cools down when operating at a reduced flow rate. This can all occur without shutting down the machine so that the machine remains productive throughout the overheat and cool down condition.

One could expect the operator to communicate propulsion control signals and implement control signals from the operator control station 16 to the electronic controller(s) 50, 26. The machine then could maneuver with power provided by engine 25 responsive to the propulsion control signals. For instance, an operator might move a joystick in operator control station 16 to command turns, forward motion and reverse motion. While this is occurring, pump 31 of the hydraulic system 30 will be driven by engine 25 to circulate hydraulic fluid to implement 18, responsive to implement control signals originating from the operator control station 16. The machine 10 will then perform work using implement 18, while electronic controller 50 monitors and the hydraulic fluid temperature utilizing temperature sensor 51. The logic illustrated in FIG. 3 will then be utilized to detect whether the hydraulic fluid temperature T reaches an elevated hydraulic fluid temperature T2. Electronic controller 50 may then derate pump 31 from a rated work tool flow rate to a reduced flow rate responsive to the elevated hydraulic fluid temperature. While this happens, the machine 10 can then continue to perform work with implement 18 at the reduced flow rate after pump 31 has been derated.

Although not necessary, the overheat protection algorithm 62 may operate in a step wise fashion to derate the pump from a work tool rated flow rate to a reduced flow rate (e.g. from a super high flow rate to a high flow rate) responsive to an elevated hydraulic fluid temperature exceeding a first elevated temperature threshold T2. However, the pump 31 might be derated to a fail safe flow rate (a standard flow rate) which is less than the high flow rate responsive to the elevated hydraulic fluid temperature exceeding a second elevated temperature T4 that is greater than the first elevated temperature T2. As stated earlier, the temperature T4 may correspond to a fail safe temperature at which electronic controller so determines a need for immediate action to protect hydraulic system 30, whereas hydraulic fluid temperatures between T2 and T4 might correspond to a lesser concern, but a range at which significant productivity may be maintained while the machine design permits the hydraulic fluid temperature to cool down during most operating conditions. If machine 10 operates as expected, the logic may re-rate the pump up to the work tool rated flow rate responsive to the hydraulic fluid temperature dropping substantially below an elevated hydraulic fluid temperature of concern. For instance, if the hydraulic fluid temperature reached a fail safe temperature, but eventually cooled down back into a normal temperature range (less than 90° C.) the logic would re-rate the pump 31 to permit the full rated work tool flow rate.

Those skilled in the art will appreciate that many implements suitable for use with machine 10 may have a rated work tool flow rate that is less than the reduced flow rate imposed by the over heat protection algorithm 60. This logic presupposes that the properly functioning machine 10 ought to be incapable of overheating hydraulic system 30 when using implements 18 requiring only a standard flow rate. Nevertheless, those skilled in the art will appreciate that the principles of the present disclosure could be applied to machines that utilize implements that operate with any flow rates. Although the present disclosure teaches the utilization of a swash plate pump 31, and varying the pump rate by changing an angle of the swash plate, the present disclosure contemplates any type of implement pump 31 as being compatible with the present disclosure. In addition, although the disclosure is illustrated in the context of a skid steer type machine in which the machine is propelled by independent left side and right side propulsion pumps, any propulsion strategy (e.g., mechanical, hydraulic as shown, electric motors) could potentially fall within the scope of the present disclosure, and many different hydraulic system configurations would also fall within the present disclosure. Thus, the present disclosure could potentially apply to an electrically propelled machine with a hydraulic system that bore little resemblance to the schematic illustrated in FIG. 2.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

1. A skid steer type machine comprising:
a machine body supported by a left side propulsion drive and a right side propulsion drive that are independently operable;
an operator control station attached to the machine body between the left and right propulsion drives;
an engine positioned rearward of the operator control station on the machine body;
a hydraulic system that includes a hydraulic fluid tank fluidly connected to an implement pump, and at least one propulsion pump driven by the engine;
a temperature sensor operably positioned to sense a hydraulic fluid temperature;
an electronic controller in communication with the hydraulic system and the temperature sensor, and programmed to execute an overheat protection algorithm configured to derate the implement pump responsive to an elevated hydraulic fluid temperature without undermining machine mobility by continuing engine operation to drive the at least one propulsion pump;
wherein the implement pump is operable up to a rated flow rate when the hydraulic fluid temperature is below an elevated temperature threshold, but operable up to a reduced flow rate, which is greater than half the rated flow rate, when derated.

2. The skid steer type machine of claim 1 wherein the overheat protection algorithm is configured to stepwise derate to a cooldown derate above a first elevated temperature threshold, and then to a fail safe derate above a second elevated temperature that is greater than the first elevated temperature.

3. The skid steer type machine of claim 1 wherein overheat protection algorithm is configured to re-rate the implement pump after a derate without hysteresis responsive to a hydraulic fluid temperature lower than the elevated temperature threshold.

4. The skid steer type machine of claim 1 wherein the electronic controller includes a work tool flow rate configuration algorithm configured to limit a flow rate of the implement pump up to a rated work tool flow rate, which is less than the reduced flow rate; and
the rated work tool flow rate is communicated to the electronic controller by the implement.

5. The skid steer type machine of claim 1 wherein the implement pump is a variable swash plate pump;
the temperature sensor is located to sense inlet temperature to the swash plate pump
the at least one propulsion pump includes a left side propulsion pump and a right side propulsion pump that are directly driven by the engine in addition to the swash plate pump.

6. The skid steer type machine of claim 1 including an electronic engine controller programmed to execute an engine overheat algorithm configured to derate the engine responsive to an elevated engine temperature; and
wherein the engine is operable up to a rated power output when the engine temperature is below an engine overheat temperature threshold, but operable up to a reduced power output when derated.

7. The skid steer type machine of claim 6 wherein the overheat protection algorithm is configured to stepwise derate to a cooldown derate above a first elevated temperature threshold, and then to a fail safe derate above a second elevated temperature that is greater than the first elevated temperature;
the overheat protection algorithm is configured to re-rate the pump after a derate without hysteresis responsive to a hydraulic fluid temperature substantially lower than the first elevated temperature threshold;
the electronic controller includes a work tool flow rate configuration algorithm configured to limit a flow rate of the pump up to a rated work tool flow rate, which is less than the reduced flow rate;
the implement pump is a variable swash plate pump;
the temperature sensor is located to sense inlet temperature to the swash plate pump and
the at least one propulsion pump includes a left side propulsion pump and a right side propulsion pump that are directly driven by the engine in addition to the swash plate pump.

8. A method of operating a machine, comprising the steps of:
communicating propulsion control signals and implement control signals from an operator control station to an electronic controller;
maneuvering the machine with power provided by an engine responsive to the propulsion control signals;
driving an implement pump and at least one propulsion pump of a hydraulic system with an engine;
circulating hydraulic fluid to an implement of a hydraulic system responsive to the implement control signals;
performing work with the implement during the maneuvering step;
determining a hydraulic fluid temperature;
detecting that the hydraulic fluid temperature indicates an elevated hydraulic fluid temperature;
derating the implement pump from a rated flow rate to a reduced flow rate responsive to the elevated hydraulic fluid temperature without undermining machine mobility; and
continuing to perform work with the implement at the reduced flow rate after derating the implement pump without undermining machine mobility.

9. The method of claim 8 wherein the derating step includes the steps of:
derating the implement pump from a rated flow rate to a reduced flow rate responsive to the elevated hydraulic fluid temperature exceeding a first elevated temperature threshold; and
derating the implement pump to a fail safe flow rate, which is less than the reduced flow rate, responsive to the elevated hydraulic fluid temperature exceeding a second elevated temperature that is greater than the first elevated temperature.

10. The method of claim 8 including a step of re-rating the implement pump up to the rated flow rate responsive to the hydraulic fluid temperature dropping below the elevated hydraulic fluid temperature.

11. The method of claim 8 including the steps of:
determining a rated implement flow rate responsive to attaching the implement to the machine; and
limiting a flow rate of the implement pump up to a rated work tool flow rate, which is less than the reduced flow rate.

12. The method of claim 8 including a step of varying an implement pump flow rate by changing an angle of a swash plate of the pump;
sensing an inlet temperature to the swash plate pump; and
propelling the machine with a left side propulsion pump and a right side propulsion pump of the at least one propulsion pump, respectively, that are directly driven by the engine in addition to the swash plate pump.

13. The method of claim 8 including a step of executing an engine overheat algorithm configured to derate the engine responsive to an elevated engine temperature; and
operating the engine up to a rated power output when the engine temperature is below an engine overheat temperature threshold, but operating the engine up to a reduced power output when the engine is derated.

14. The method of claim 13 wherein the derating step includes the steps of: derating the implement pump from a rated flow rate to a reduced flow rate responsive to the elevated hydraulic fluid temperature exceeding a first elevated temperature threshold; and derating the implement pump to a fail safe flow rate, which is less than the reduced flow rate, responsive to the elevated hydraulic fluid temperature exceeding a second elevated temperature that is greater than the first elevated temperature;
re-rating the implement pump up to the rated flow rate responsive to the hydraulic fluid temperature dropping substantially below the first elevated hydraulic fluid temperature.
determining a rated implement flow rate responsive to attaching the implement to the machine;
limiting a flow rate of the implement pump up to a rated work tool flow rate, which is less than the reduced flow rate;
varying the flow rate of the implement pump by changing an angle of a swash plate of the implement pump;
sensing an inlet temperature to the implement pump; and
propelling the machine with a left side propulsion pump and a right side propulsion pump of the at least one propulsion pump, respectively, that are directly driven by the engine in addition to the implement pump.

15. A machine comprising:
a machine body supported by a propulsion system;
an operator control station attached to the machine;
an engine positioned on the machine body;
a hydraulic system that includes a hydraulic fluid tank fluidly connected to an implement pump and at least one propulsion pump driven by the engine;
a temperature sensor operably positioned to sense a hydraulic fluid temperature;
an electronic controller in communication with the hydraulic system and the temperature sensor, and programmed to execute an overheat protection algorithm configured to derate the implement pump responsive to an elevated hydraulic fluid temperature;
wherein the implement pump is operable up to a rated flow rate when the hydraulic fluid temperature is below an elevated temperature threshold, but operable up to a reduced flow rate, when derated without undermining machine mobility by continuing engine operation to drive the at least one propulsion pump; and
wherein the reduced flow rate corresponds to a hydraulic system cool down flow rate while maintaining the engine operating up to an engine rated condition to maintain a machine productivity when the implement pump is derated.

16. The machine of claim 15 wherein the overheat protection algorithm is configured to stepwise derate the implement pump from a rated flow rate to a reduced flow rate responsive to the elevated hydraulic fluid temperature exceeding a first elevated temperature threshold; and
derating the implement pump to a fail safe flow rate, which is less than the reduced flow rate, responsive to the elevated hydraulic fluid temperature exceeding a second elevated temperature that is greater than the first elevated temperature.

17. The machine of claim 16 wherein overheat protection algorithm is configured to re-rate the implement pump after a derate without hysteresis responsive to a hydraulic fluid temperature lower than the elevated temperature threshold.

18. The machine of claim 17 wherein the electronic controller includes a work tool flow rate configuration algorithm configured to limit a flow rate of the implement pump up to a rated work tool flow rate, which is less than the reduced flow rate; and
the rated work tool flow rate is communicated to the electronic controller by the implement.

19. The machine of claim 18 wherein the implement pump is a variable swash plate pump;
the temperature sensor is located to sense inlet temperature to the swash plate pump; and
the at least one propulsion pump includes a left side propulsion pump and a right side propulsion pump directly driven by the engine in addition to the swash plate pump.

20. The machine of claim 19 including an electronic engine controller programmed to execute an engine overheat algorithm configured to derate the engine responsive to an elevated engine temperature; and
wherein the engine is operable up to a rated power output when the engine temperature is below an engine overheat temperature threshold, but operable up to a reduced power output when derated.
